(19) United States
(12) Patent Application Publication
(10) Pub. No.: US 2008/0148270 A1
(43) Pub. Date: Jun. 19, 2008

(54) METHOD AND IMPLEMENTATION FOR STORAGE PROVISIONING PLANNING

(75) Inventors: Sandeep K. Gopisetty, Morgan Hill, CA (US); Madhukar R. Korupolu, Sunnyvale, CA (US); Kaladhar Voruganti, San Jose, CA (US); Omer Ahmed Zaki, San Jose, CA (US)

Correspondence Address: CANTOR COLBURN, LLP - IBM ARC DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/611,488

(22) Filed: Dec. 15, 2006

(51) Int. Cl. G06F 9/46

(52) U.S. Cl. 718/104

(57) ABSTRACT

A method for storage provisioning planning including integrating capacity and provisioning planning operations. Afterwards, the method proceeds by switching via policy between integrated capacity and provisioning planning operations. The method further includes constructing an end-to-end resource model and selecting a plurality of pools based on the end-to-end resource model. Subsequently, the method includes filtering via policy between a plurality of heterogeneous controllers having resource graphs. The resource graphs contain various levels of detail. The resource graphs having hosts, switches, and storage controllers are dynamically pruned, such pruning being predicated upon the monitored performance characteristics.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of Invention

This invention relates in general to storage volume, and more particularly, to creating a volume in an existing storage environment via provisioning planning.

2. Description of Background

Currently, the task of allocating storage volumes is a manual, error-prone and time-consuming process. When enterprise customers want to provision the required storage for their applications, many of the customers in many of the cases request the field representative from the storage vendor to perform this task. The field representatives, in turn, make measurements to determine the current utilization (both space and performance) of the existing storage controllers, and then propose a plan for the creation of the storage volumes. In addition to performance and capacity, the field representatives also take future growth, security, and disaster recovery/availability and reliability characteristics into account. It is important to get the location for creating a volume correct in order to avoid application performance degradation.

Furthermore, relying on subsequent migration of data between the storage arrays or controllers does not scale well with respect to resource utilization if the size of the data is large. Therefore, storage vendors are providing storage management tools that automatically discover the capacity and performance statistics of the storage controllers and then determine the most suitable location for creating new storage volumes. Capacity planning and provisioning planning are two types of planning that are performed by storage administrators. Capacity planning is performed when an organization wants to deploy a new storage infrastructure or extend an existing storage infrastructure. Provisioning planning is typically performed when one is trying to determine where to create a volume in an existing storage environment.

Thus, there is a need for a method for storage provisioning planning that addresses (i) the lack of integration between capacity and provisioning planners, (ii) not dealing with heterogeneous controllers during provisioning planning, and (iii) not considering networks and hosts during provisioning planning.

### SUMMARY OF THE INVENTION

The shortcomings of the prior art are overcome and additional advantages are provided through the provision of a method for storage provisioning planning, including integrating capacity and provisioning planning operations. Then, switching via policy between integrated capacity and provisioning planning operations. The method further includes constructing an end-to-end resource model and selecting a plurality of pools based on the end-to-end resource model. Subsequently, the method includes filtering via policy between a plurality of heterogeneous controllers having resource graphs. The resource graphs contain various levels of detail. The resource graphs having hosts, switches, and storage controllers are dynamically pruned, such pruning being predicated upon the monitored performance characteristics.

Additional features and advantages are realized through the techniques of the present invention. Other embodiments and aspects of the invention are described in detail herein and are considered a part of the claimed invention. For a better understanding of the invention with advantages and features, refer to the description and to the drawing.

### TECHNICAL EFFECTS

As a result of the summarized invention, technically we have achieved a solution for a method for storage provisioning planning.

### BRIEF DESCRIPTION OF THE DRAWINGS

The subject regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 illustrates one example of a method for storage provisioning planning.

The detailed description explains an exemplary embodiment of the invention, together with advantages and features, by way of example with reference to the drawing.

### DETAILED DESCRIPTION OF THE INVENTION

Embodiments address shortcomings in current storage provisioning planning tools. One shortcoming is the lack of integration between capacity and provisioning planners. Currently, if a provisioning planning tool does not find a solution that satisfies capacity and performance needs of the input volume sizes, the provisioning planning tool simply returns an error to the user. Yet, it is desirable to allow the user to invoke focused capacity planning to alleviate contention at the specific bottlenecked resource. Focused capacity planning is different than general full-fledged capacity planning because focused capacity planning is more heavily concentrated on processing speed instead of solution optimality. Another shortcoming is not dealing with heterogeneous controllers during provisioning planning. Controllers may vary in their functionality with respect to their performance, capacity, availability, security, and characteristics. Therefore, if there are storage pools from controllers of two different types that are both only fifty percent (50%) utilized, then there is no clear way of deciding how to choose one controller over the other. One could use cost per megabyte to choose one controller over the other. Similarly, in addition to performance, one needs to consider availability, security, future growth, disaster recovery, and characteristics to choose between the characteristics of the different controllers. Another shortcoming is not considering networks and hosts during provisioning planning. That is, existing solutions do not consider network and storage resource graphs in an integrated manner. When a host desires storage, it is important to consider the performance of the entire path from the host to the storage controller. One needs to consider not only the performance characteristics of storage arrays, but one also needs to consider the performance characteristics of host bus adapters (HBAs) and fabric. More importantly, one needs a mechanism to deal with competing alternatives with different combinations of fabric and storage controller bottlenecks. For example, the fabric is not a bottleneck but the storage array is a bottleneck in alternative 1, versus alternative 2, where the storage array is not a bottleneck but the fabric is a bottleneck.

Embodiments includes a provisioning planning algorithm and infra-structure that deals with: (a) heterogeneous controllers, (b) provides integrated provisioning and capacity planning, and (c) looks at complete host, network, and storage resource graphs in an integrated manner.

Embodiments use a combined host, network and storage resource graph. Existing volume placement planning mechanisms do not consider host, network and storage resource graphs in an integrated manner. That is, existing mechanisms only consider storage controller resource graphs. A typical storage controller resource graph consists of storage controller cluster-device adapter storage pool (storage rank or array) volume. This graph does not consider the resource bottleneck impact at the host and in the fabric. Therefore, one could potentially recommend the use of a pool on a storage controller that is not heavily utilized, but the network connection from the host to the storage controller could be a bottleneck. Thus, embodiments use a resource graph, which in addition to storage controllers also includes host and fabric components. The combined resource graph proposed includes host ports, which may also be storage controller ports when dealing with controller to controller flows, port-to-port connections where the ports could be host, storage or switch ports, clusters, device adapters, pools (ranks and arrays) and volumes.

Embodiments combine capacity and provisioning planning. Once the provisioning planner determines that there is no volume or path that satisfies the user requirements, the planner switches to the capacity-planning mode. The provisioning planner's output pinpoints the bottlenecked resource. This, in turn, is passed on as input to the capacity-planning tool. So, the capacity planning operation is focused on trying to alleviate the bottleneck. Adding new resources, or upgrading the capacity of an existing resource, or rewiring devices may alleviate bottlenecks. The switching between provisioning and capacity planning may be based on policies.

Embodiments deal with heterogeneous controllers. An organization may deploy controllers of different types with different performance, availability, capacity, and functional characteristics. Thus, when multiple controllers can satisfy the performance and capacity requirements it is necessary to use other criteria (policies) to select a specific controller.

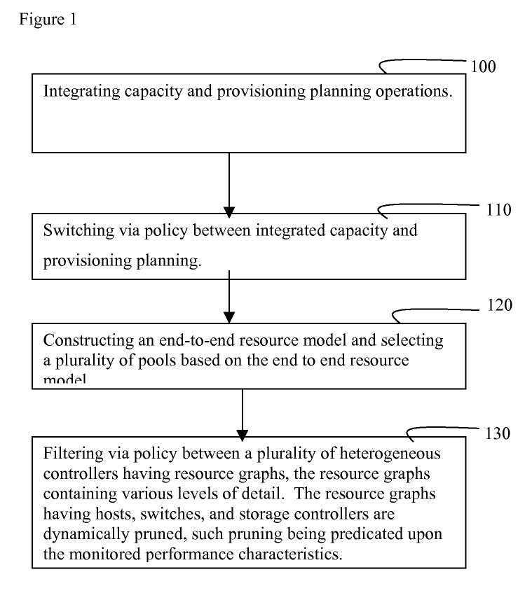

Referring to FIG. 1, a method for storage provisioning planning, is shown. At step 100, the capacity and provisioning planning operations are integrated. Subsequently, at step 110, policy based switching between capacity and provisioning planning operations takes place.

At step 120, an end-to-end resource model construction is executed, and a selection of pools based upon the end-to-end resource model construction is chosen. Afterwards, at step 130, policy based filtering is executed between heterogeneous controllers. The resource graphs of these heterogeneous controllers may be of different levels of detail. For example, for IBM controllers, there is an extremely detailed level of storage controller resource graphs that contain an abundance of internal components. In contrast, for a non-IBM controller, there is a resource graph with fewer nodes in the graph. The type of resource graph to use is dynamically chosen based on the controller type being utilized.

The resource graphs having hosts, switches, and storage controllers are dynamically pruned, such pruning being predicated upon the monitored performance characteristics. More specifically, provided the host bus adapter cards are not bottlenecks, or if the switches are not bottlenecks, then the host bus adapter cards and switches are dynamically removed from consideration. The host bus adapter cards and switches are dynamically added at a later time frame provided the resources are observed being highly utilized. The capability of dynamically adding and removing the resource graph nodes allows the resource graph processing to scale and perform better when a large capacity of nodes are in the graph.

The configuration and performance statistics of the plurality of hosts, the plurality of switches and the plurality of storage controllers are queried. The performance characteristics of the concerned devices can be either directly probed via the common information model (CIM) queries, or they may be retrieved from a performance database that is also capable of storing historical data. The resource graph includes hosts, HBAs, ports, switch ports, switches, storage controller ports, storage controller process complexes, storage controller backend device adapters, storage controller pools, storage controller ranks, storage controller arrays.

Both the throughput as well as the input/output processor (IOP) metrics are measured and stored for each of the nodes in the resource graph. The full fabric path information, host port to switch port, switch port to switch port, and switch port to storage controller port is stored in the resource graph instead of storing just the initial host port and final storage port information in order to identify the potential fabric bottlenecks.

The host and fabric resource graph components among the plurality of storage controllers are shared. A separate resource graph is constructed for each of the storage controllers. The storage controller resource graph includes storage controller host side ports and it goes down all the way to the storage controller arrays.

All of the storage controller pools (and their associated ranks and arrays) that have the necessary amount of space and excess performance capacity are selected via a storage pool selection algorithm.

The pool selection algorithm selects all the possible host ports, fabric and storage pool combinations that may potentially satisfy the space and performance requirements. Device interoperability constraints are taken into account.

Pool filtering is executed by at least one of, (i) user device type preferences used to filter storage controllers, (ii) controller availability ratings used to filter storage controllers, (iii) controller functionality such as copy services, security and cache size used to filter out storage controllers. Controllers are filtered based on whether they have the access capacity to satisfy the future growth requirements with respect to both bandwidth and capacity.

The cost per megabyte criteria is used to filter down potential storage controllers. It is important to note that aggregating a bunch of smaller storage controllers instead of using a large storage controller with a larger number of ports may increase the fabric cost because the storage to fabric port ratio is better amortized in larger controllers.

The remaining pool of storage controllers all satisfies the performance, capacity and the policies previously described. As such, it is necessary to further order the remaining set based on the performance utilization criteria at step 160. Users may specify policies that control how to select the resources. Such policies may include use of the least utilized storage controller, the network fabric and the host ports. This helps to balance load on the system resources. Secondly, the policies may assign higher priority to storage resource utilization over network resource utilization. More particularly, accommodating the least utilized storage resources first, and then finding the corresponding network and host resources that are connected to these storage resources. Similarly, the option of having policies that provide higher priority to network or host resources may be used.

Provided multiple candidates remain, the user may choose one of the remaining storage pools in a random manner. While performing provisioning planning, the user may select to over-commit a resource and let it become a bottleneck. Alternatively, the user could specify a policy that triggers capacity planning when one of the concerned resources exceeds a predefined threshold. Additionally, the user could select to take all or nothing approach for the remaining unfulfilled capacity.

The focused capacity planning operation looks at the congested resource and then it determines all the paths that are affected due to this congestion. The capacity planner considers fabric re-wiring operations, as well as the addition of new resources, or resource upgrades or a combination of all. Migration of data between storage controllers is only considered as an option under abnormal conditions (hierarchical migration of data from disk to tape is considered as a normal mode of operation).

In addition to capturing performance, capacity, security, availability in account, the capacity planner also considers both cost as well as future growth trends. For some types of resource additions one can take a greedy approach, whereas, for other types of resource addition, one has to take a long-term objective into consideration. For example, when one needs to add an edge switch that connects a host to the fabric it is sufficient to simply add a new edge switch if there are no spare edge switch ports available. However, when one wants to increase the capacity of the core fabric, it is usually not desirable to do this in an incremental manner because making changes to the core fabric usually results in the re-wiring of the entire fabric and this is a very costly and error-prone operation. At the conclusion of the capacity planning, one typically procures the hardware equipment, and then invokes a workflow to perform the necessary storage and network provisioning tasks.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for storage provisioning planning, comprising:
integrating capacity and provisioning planning operations;
switching via policy between integrated capacity and provisioning planning operations;
constructing an end to end resource model and selecting a plurality of pools based on the end to end resource model;
filtering via policy between a plurality of heterogeneous controllers having resource graphs, the resource graphs containing various levels of detail; and
wherein the resource graphs having hosts, switches, and storage controllers are dynamically pruned, such pruning being predicated upon the monitored performance characteristics.

2. The method of claim 1, further including:
querying configuration and performance statistics of the plurality of hosts, the plurality of switches and the plurality of storage controllers.

3. The method of claim 2, further including:
measuring and storing throughput and input/output processor (IOP) metrics for each node in each resource graph.

4. The method of claim 3, further including:
sharing host and fabric resource graph components among the plurality of storage controllers.

5. The method of claim 4, further including:
selecting all of the storage controller pools.

6. The method of claim 5, further including:
selecting all host ports, fabric and storage pool combinations that satisfy space and performance threshold requirements.

7. The method of claim 6, further including:
executing pool filtering on the selected combinations.

8. The method of claim 7, further including:
ordering a remaining pool of storage controllers via performance utilization criteria.

9. The method of claim 8, wherein pool filtering includes:
filtering the storage controllers via user device type preferences.

10. The method of claim 9, wherein pool filtering further includes:
filtering the storage controllers via a controller availability rating.

11. The method of claim 10, wherein pool filtering further includes:
filtering the storage controllers via controller functionality.

12. The method of claim 11, wherein the storage controllers are filtered when each storage controller possesses an access capacity to satisfy future growth requirements pertaining to bandwidth and capacity.

13. The method of claim 12, wherein the resources utilized for ordering the pool of storage controllers is selected from at least one of, (i) use of the least utilized storage controller, the network fabric and the host ports, and (ii) assigning higher priority to storage resource utilization over network resource utilization.

14. The method of claim 13, further including:
selecting one of the remaining storage pools provided multiple candidates remain.

15. The method of claim 14, wherein selecting one of the remaining storage pools while performing provisioning planning involves at least one of, (i) selecting to over commit a resource such that the resource behaves as a bottleneck, (ii) specifying a policy that triggers capacity planning provided one of the resources exceeds a predefined threshold, (iii) accepting at least one of, (a) all and (b) nothing approach to provisioning planning, and (iv) performing partial provisioning and performing capacity planning for the remaining unfulfilled capacity.
